(19) United States
(12) Patent Application Publication
(10) Pub. No.: US 2011/0247752 A1
(43) Pub. Date: Oct. 13, 2011

(54) METHOD FOR CONNECTING A RUBBER BEARING OR A RUBBER-METAL BEARING TO A BEARING SEAT

(75) Inventor: PETER KOCZAR, Wiesbaden (DE)

(73) Assignee: Benteler Automobiltechnik GmbH, Paderborn (DE)

(21) Appl. No.: 13/079,980

(22) Filed: Apr. 5, 2011

(30) Foreign Application Priority Data
Apr. 8, 2010 (DE) 102010014258.1-12

(51) Int. Cl. B32B 37/06; B32B 37/12

(52) U.S. Cl. 156/275.7; 156/293

(57) ABSTRACT

A method for connecting a rubber bearing or a rubber-metal bearing to a bearing seat of a vehicle bearing includes applying a bonding agent on a surface of the bearing seat facing the rubber bearing or the rubber-metal bearing, and performing vulcanization after the rubber bearing or the rubber-metal bearing has been pressed into the bearing seat.

### CROSS-REFERENCES TO RELATED APPLICATIONS

This application claims the priority of German Patent Application, Serial No. 10 2010 014 258.1-12, filed Apr. 8, 2010, pursuant to 35 U.S.C. 119(a)-(d), the content of which is incorporated herein by reference in its entirety as if fully set forth herein.

### BACKGROUND OF THE INVENTION

The present invention relates to a method for connecting a rubber bearing or a rubber-metal bearing to a bearing seat of a vehicle bearing.

The following discussion of related art is provided to assist the reader in understanding the advantages of the invention, and is not to be construed as an admission that this related art is prior art to this invention.

Chassis bearings are used to provide to steer or isolate a chassis of a motor vehicle. They are installed in axle systems and control arms as elastic articulated joints. Frequently, coaxially layered rubber-metal bearings with a metallic bearing core are used. The rubber-metal bearing is generally screwed to the chassis via the bearing core. The connection to the bearing core is established by vulcanizing an elastomer layer or a rubber layer. The connection to the outside component, i.e., to the bearing seat, is performed by pressing, so that the elastomer or rubber layer is elastically prestressed.

Disadvantageously, relative movements can occur in conventional chassis bearings between the rubber-metal bearing and the bearing seat, which in turn produce undesirable friction and damping. Wear and the tendency to generate noise also increase.

It would therefore be desirable and advantageous to provide an improved method for producing a vehicle bearing to obviate prior art shortcomings and to prevent problems such as relative movements of the rubber bearing or a rubber-metal bearing relative to the bearing seat.

### SUMMARY OF THE INVENTION

According to one aspect of the present invention, a method for connecting a rubber bearing or a rubber-metal bearing to a bearing seat of a vehicle bearing, includes applying a bonding agent on a surface of the bearing seat facing the rubber bearing or rubber-metal bearing, pressing the rubber bearing or rubber-metal bearing into the bearing seat, and vulcanizing the rubber bearing or rubber-metal bearing in the bearing seat. With this later vulcanization, a material connection is established via the bonding agent between a rubber layer and the bearing seat of the vehicle bearing.

According to an advantageous feature of the invention, the rubber bearing may, for example, have a tubular shape if a simple rubber bearing is employed.

According to an advantageous feature of the invention, the bonding agent may be applied by spraying or brushing. However, the bonding agent may also be applied on the surface of the bearing seat by rolling. Importantly, the bonding agent may be applied uniformly over the entire area.

By pressing the rubber bearing or the rubber-metal bearing into the bearing seat, a full-surface close contact is advantageously established between the bonding agent and the rubber bearing or the rubber layer of the rubber-metal bearing due to the two-dimensional press fit between the rubber layer and the bearing seat. The bonding agent hereby ensures a uniform connection between the rubber bearing and/or the rubber layer of the rubber-metal bearing and the bearing seat after vulcanization.

According to an advantageous feature of the invention, thermal energy required for the vulcanization may be supplied to the bearing seat and the rubber bearing or the rubber-metal bearing in form of hot air. However, the bearing seat or the rubber bearing or the rubber-metal bearing may also be heated by contact heating. In an alternative embodiment, inductive heating may be employed. According to an advantageous feature of the invention, vulcanization may be performed at temperatures between a minimum of 100° C. and a maximum of 180° C. Particularly advantageous for the vulcanization are temperatures between 140° C. and 160° C.

The uniform press fit between the rubber bearing, or the rubber-metal bearing, and bearing seat attainable through a pressing action supports the formation of a uniform material connection between the rubber bearing and the rubber layer of the rubber-metal bearing, respectively, and the bonding agent. In this way, relative movements between the bearing seat and the rubber bearing or the rubber-metal bearing can be prevented.

According to an advantageous feature of the invention, multilayer rubber-metal bearings having several rubber layers can be produced with the method of the invention in addition to rubber bearings or simple rubber-metal bearings having only a single rubber layer. The rubber layers in such multilayer rubber-metal bearings may advantageously be mutually separated by a corresponding intermediate layer. This intermediate layer may advantageously be made of metal. Multilayer rubber-metal bearings may be connected to a bearing seat by pressing the rubber-metal bearings into a bearing seat that was previously prepared with a bonding agent, and subsequently vulcanized.

According to an advantageous feature of the invention, particularly with multilayer rubber-metal bearings, the rubber layer facing the bearing core and the bearing core can also be connected by vulcanization after the bearing core has been pressed in. This approach may prevent a potential relative movement between the bearing core and the rubber-metal bearing. The required bonding agent may here be applied to a surface of the bearing core facing the rubber layer. Advantageously, the bearing core may here also be pressed in, wherein the uniform two-dimensional press fit between bearing core and rubber layer ensures uniform connection after vulcanization.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a simple rubber-metal bearing, and

FIG. 2 shows a rubber-metal bearing with an intermediate layer.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

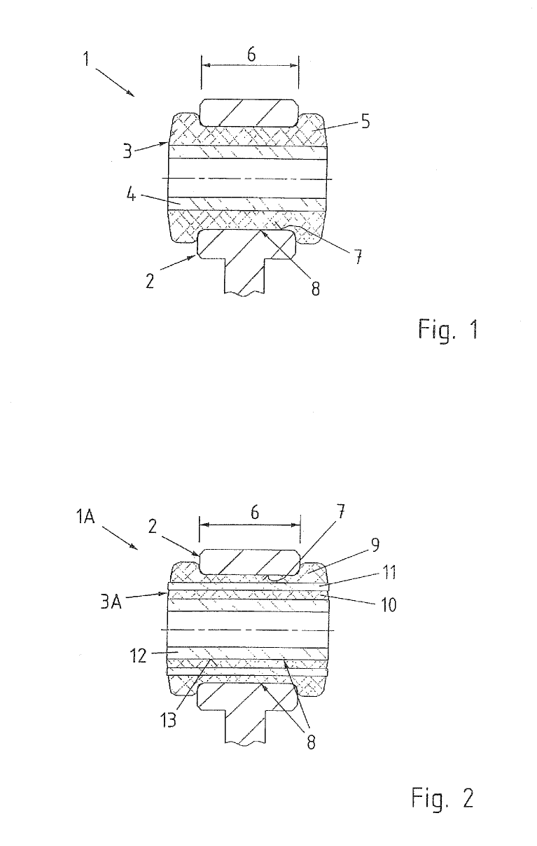

Turning now to the drawing, and in particular to FIG. 1, there is shown a chassis bearing 1 which includes a bearing seat 2 with a rubber-metal bearing 3. The rubber-metal bearing 3 includes a bearing core 4 with a rubber layer 5. The rubber-metal bearing 3 is pressed into a bearing seat 2 of the chassis bearing 1. The rubber layer 5 is thereby elastically prestressed or compressed in a joint region 6 between the bearing seat 2 and the rubber-metal bearing 3. A uniform two-dimensional press fit between the rubber layer 5 and the bearing seat 2 is formed in the joint region 6.

A material connection between the bearing seat 2 and the rubber layer 5 of the rubber-metal bearing 3 in a joint region 6 is attained by performing vulcanization after the rubber-metal bearing 3 has been pressed into the bearing seat 2. To this end, a bonding agent 8 is applied on a surface 7 of the bearing seat 2 facing the rubber layer 5, before the rubber-metal bearing 3 is pressed in.

FIG. 2 shows a chassis bearing 1A with a multilayer rubber-metal bearing 3A which in this embodiment has two rubber layers 9, 10. An intermediate layer 11 made of metal is arranged between the rubber layers 9, 10. The rubber-metal bearing 3A is here also connected to the bearing seat 2 by vulcanization after the rubber-metal bearing 3A is pressed into the bearing seat 2 prepared to the bonding agent 8.

The rubber layer 9 of the rubber-metal bearing 3A facing the bearing seat 2 is here also in a compressed state in the joint region 6 to the bearing seat 2, i.e., rubber layer 9 contacts the surface 7 of the bearing seat 2, on which the bonding agent 8 is applied, across the entire surface area and with an elastic pretension. In this way, after the later vulcanization, a two-dimensional connection is established between the bearing seat 2 and the rubber-metal bearing 3A.

In one exemplary embodiment, using the same process, a bearing core 12 of the multilayer rubber-metal bearing 3A was connected to the interior rubber layer 10. To this end, a bonding agent 8 was applied on the outer peripheral surfaces 13 before the bearing core 12 was pressed in. During the vulcanization, the abutting rubber layer 10 then bonds with this bonding agent 8, thereby materially connecting the bearing core 12 to the rubber-metal bearing 3A. By pressing the bearing core 12 in, the rubber layer 10 is forced into uniform contact to the peripheral surface 13, thereby producing a uniform connection between the rubber-metal bearing 3A and the bearing core 12.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for connecting a rubber bearing or a rubber-metal bearing with a bearing seat of a chassis bearing, comprising the steps of:
applying a bonding agent on a surface of the bearing seat facing the rubber bearing or rubber-metal bearing,
pressing the rubber bearing or rubber-metal bearing into the bearing seat, and
vulcanizing the rubber bearing or rubber-metal bearing inside the bearing seat.

2. The method of claim 1, wherein the bonding agent is applied by at least one of spraying, brushing and rolling.

3. The method of claim 1, wherein thermal energy for vulcanization is provided by hot air, contact heating or inductive heating.

4. The method of claim 1, wherein vulcanization takes place at a temperature between 100° C. and 180° C.

5. The method of claim 4, wherein vulcanization takes place at a temperature between 140° C. and 160° C.

6. The method of claim 1, further comprising the step of connecting a bearing core to a rubber layer of the rubber bearing or the rubber-metal bearing by vulcanization.
